(19) United States
(12) Patent Application Publication
(10) Pub. No.: US 2015/0339688 A1
(43) Pub. Date: Nov. 26, 2015

(54) SELECTIVE VIRAL DISPLAY SOCIAL MARKETING AND SALES SYSTEM

(71) Applicant: Dak Brandon Steiert, Edwards, CO (US)

(72) Inventor: Dak Brandon Steiert, Edwards, CO (US)

(21) Appl. No.: 14/716,881

(22) Filed: May 20, 2015

Related U.S. Application Data
(60) Provisional application No. 62/001,839, filed on May 22, 2014.

(51) Int. Cl. G06Q 30/02; G06Q 50/00

(52) U.S. Cl. CPC G06Q 30/0204; G06Q 30/0222; G06Q 50/01

(57) ABSTRACT

The electronic sales and marketing system of the preferred embodiments includes an algorithm stored on computer-readable medium and carried out by one or more networked computer devices, wherein the algorithm includes showing a post containing one or more of A) one or more products for sale, B) one or more services for sale, and C) one or more items for sale to a user; accessing information stored in computer-readable medium related to one or more additional user, if the first user one or more of: 1) designates that they feel positively about the post, 2) makes a purchase related to the contents of the post, and 3) rates or reviews the contents of the post; showing at least a portion of the contents of the post to the one or more additional users wherein the information related to the one or more other users at least one of I) suggests a social connection exists between the first user and the one or more other users, and II) shows that the first user and the one or more additional users have elected to be in at least one common group within the system, wherein the information additionally one or more of: i) suggests there may be at least one common interest between the first user and the one or more additional users, and ii) shows that the first user and the one or more additional users have stated that they have interests in at least one common area, wherein the method further comprises the ability to purchase through the electronic sales and marketing system one or more of A) one or more products for sale, B) one or more service for sale, and C) one or more items for sale to a user. The electronic sales and marketing system of the preferred embodiments has been designed to provide a viral social marketing platform that preferably encourages the spread of exposure for good products and products appreciated by users, rather than providing advertising exposure based on expenditure from the seller. The system of the preferred embodiments is further designed to show products or services to users based on the actions of other users socially connected to those users, and preferably shows products or services only to users that the system has information suggesting those users will be interested in those products or services, which is done to ensure that users see only products or services that they may be interested that are also supported by those they are socially connected to, and also to avoid showing users a large number of posts they do not have interest in. The electronic sales and marketing system of the preferred embodiments, however, may be used for any suitable purpose.

### CROSS-REFERENCE TO RELATED APPLICATIONS

This application is a non-provisional continuation of U.S. Provisional Patent Application Ser. No. 62/001,839 filed 22 May 2014 and entitled “SELECTIVE VIRAL DISPLAY SOCIAL MARKETING AND SALES SYSTEM”, the priority of which is claimed by this application, and the entire contents and substance of which are hereby incorporated in total by reference.

### BRIEF DESCRIPTION OF THE FIGURES

FIG. 1 is a schematic representation of the system of the preferred embodiments.

FIG. 2 is a schematic representation of the system of the preferred embodiments further comprising messages or rules of conduct designed to prevent post items that are not related to products or services for sale.

FIG. 3 is a schematic representation of the system of the preferred embodiments further comprising data on past usage of the system by one or more users, and a method for determining if that past usage suggests a shared interests between two or more users.

FIG. 4 is a schematic representation of the system of the preferred embodiments further comprising an automatic display of a new post to a group of users, where the group of users can include a number of users that can vary in different embodiments, and where there are rules or messages discouraging users for post anything not for sale.

FIG. 5 is a schematic representation of the system of the preferred embodiments further comprising an automatic display of a new post to a group of users, where the group of users can include a number of users that can vary in different embodiments.

FIG. 6 is a schematic representation of the system of the preferred embodiments further comprising the set of expressed interests and past actions of the user, a group of users that one or more users elect to be placed in, and the proceeds and system retained proceeds from sales.

FIG. 7 is a schematic representation of the system of the preferred embodiments further comprising rewards given back to users for carrying out a larger number or rate of actions within the system.

### DESCRIPTION OF THE PREFERRED EMBODIMENTS

The following description of the preferred embodiments of the invention is intended to enable someone skilled in the prior art to make and use this invention, but is not intended to limit the invention to these preferred embodiments.

### First Preferred Embodiment

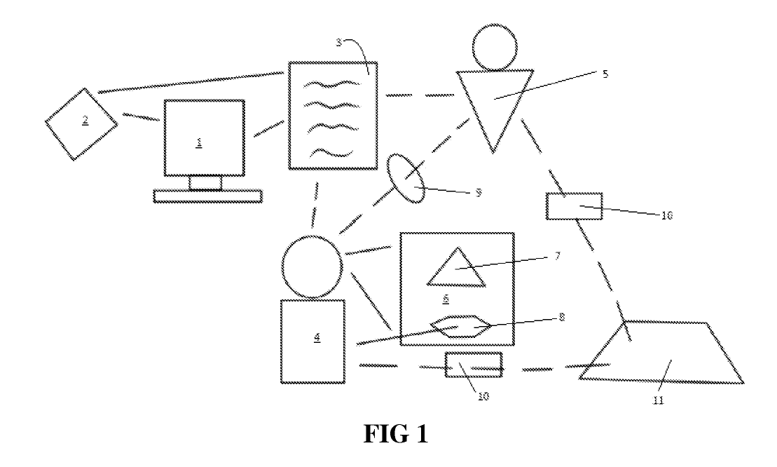

As shown in FIG. 1, the electronic sales and marketing system of the preferred embodiments includes an algorithm 2 stored on computer-readable medium 3 and carried out by one or more networked computer devices 1, wherein the algorithm 2 includes showing a post 6 containing one or more of A) one or more products for sale 7, B) one or more services for sale 7, and C) one or more items for sale 7 to a user 4; accessing information stored in computer-readable medium 3 related to one or more additional user 5, if the first user 4 one or more of: 1) designates that they feel positively about the post 6, 2) makes a purchase related to the contents of the post 6, and 3) rates or reviews the contents of the post 6; showing at least a portion of the contents of the post 6 to the one or more additional users 5 wherein the information 3 related to the one or more additional users 5 at least one of I) suggests a social connection 9 exists between the first user 4 and the one or more additional users 5, and II) shows that the first user 4 and the one or more additional users 5 have elected to be in at least one common user group 14 within the system, wherein the information 3 additionally one or more of: i) suggests there may be at least one common interest 11 between the first user 4 and the one or more additional users 5, and ii) shows that the first user 4 and the one or more additional users 5 have stated that they have interests 10 in at least one common area, wherein the system further comprises the ability to purchase through the electronic sales and marketing system one or more of A) one or more products for sale 7, B) one or more service for sale, and C) one or more items for sale 7 to a user 4. The electronic sales and marketing system of the preferred embodiments has been designed to provide a viral social marketing platform that preferably encourages the spread of exposure for good products and products appreciated by users 4, rather than providing advertising exposure based on expenditure from the seller 16. The system of the preferred embodiments is further designed to show products or services to users 4 based on the actions of additional users 5 socially connected to those users 4, and preferably shows products or services only to users 4 that the system has information 3 suggesting those users 4 will be interested in those products or services, which is done to ensure that users 4 see only products or services that they may be interested that are also supported by those they are socially connected to, and also to avoid showing users 4 a large number of posts 6 they do not have interest in. The electronic sales and marketing system of the preferred embodiments, however, may be used for any suitable purpose.

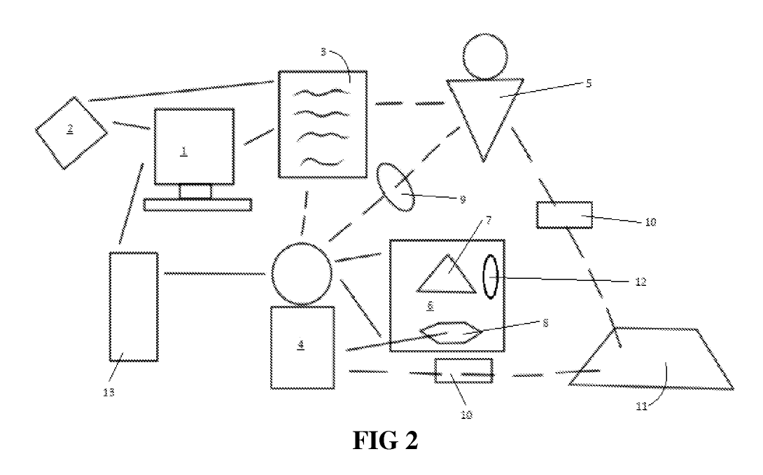

As shown in FIG. 2, a preferred variation of the system of the first preferred embodiment includes either showing one or more messages 13 to users 4 that encourage them to only make posts 6 related to products items or services for sale 7; providing rules governing the usage of the system 13 by users 4 that only allow users 4 to make posts 6 related to products, items or services for sale 7; or both of these. The messages 13, rules governing the usage of the system 13 by users 4, or both are preferably used to prevent users 4 from seeing posts 6 that don't relate to products, items or services for sale 7, so that the preferred marketing and sales purpose of the system of the preferred embodiments is not hindered by annoying users 4 or by distracting them from posts 6 related to products, items or services for sale 7. The messages 13, rules governing the usage of the system 13 by users 4, or both may, however, be used for any suitable purpose. The system of the first preferred embodiments may, however, contain any suitable messages 13 or rules governing the usage of the system 13 by users 4, or it may not contain any messages 13 or rules governing the usage of the system 13 by users 4. Because of these and other features, the system provides significant enhancement and improvement in bandwidth consumed by servers for serving data to users, a great reduction in RAM accessing and processor usage, and a significant improvement in overall memory requirements versus any other system capable of use promoting the word of products or services via social networking connections. Because not all users are shown all products, the amount of data related to products, services, and other postings that must be stored, processed, and served by the system is much smaller than any other system. This means that the experience of users and sellers in the system is greatly enhanced, the effectiveness for use in real world market transactions and the distribution of information related to products and services is increased, and also there is a significant increase in the efficiency and decrease of the load on the servers and computers used to serve, process, store and display the system of the preferred embodiments. This is due to the fact that out of the hundreds or even thousands of interests or other characteristics all the users on any network might have collectively, any one user will have only a fraction of those interests or characteristics, which means that selective display of information related to products and services by taking into account the interests and characteristics of the user will inherently cause a great reduction in the number and frequency of display incidents required to execute the processes embodied by the system as compared to any prior art systems.

As shown in FIG. 2, a preferred variation of the system of the first preferred embodiments may include rules of conduct for sellers 16 using the system requiring sellers 16 to provide discounts 12 compared to at least one of A) market value, B) the standard sales price, and C) the minimum sales price in the market for one or more of 1) one or more products for sale 7, 2) one or more services for sale 7, and 3) one or more items for sale 7 to a user 4. Preferably, sellers 16 on the system are required to offer discounts 12 for products, items or services 7 that they sell using system of the preferred embodiments in order to encourage users 4 to buy items or services 7 using the system of the preferred embodiments. Preferably sellers 16 on the system are additionally required to offer discounts 12 for products, items or services 7 that they sell using the system of the preferred embodiments in exchange for the benefit they receive of a platform that provides free exposure for their products to the users 4 of the system. The sellers 16 using the system may, however, be held to any suitable standards for conduct or usage. In a variation of the system of the preferred embodiments, the sellers 16 may be required to choose between two or more options that will entice users 4 to buy from the system of the preferred embodiments, these options may include: providing discounts 12, providing randomized discounting where buyers are eligible to receive a randomized discount 12 on their purchase after they commit to buy, and an option to bid on products. Any suitable option to entice users 4 to buy from the system of the preferred embodiments can be used. There may, however, be no options provided for the sellers 16 to choose between to change the purchasing experience of users 4.

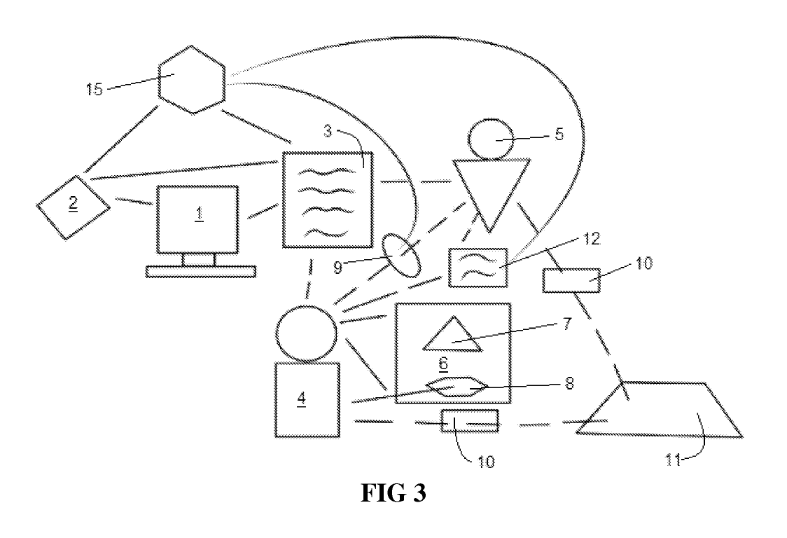

As shown in FIG. 3, the algorithm 2 further comprises a method 15 to determine if information stored in computer-readable medium 3 related to a user 4 and one or more additional users 5 suggest there may be one or more common interests 11 between the user 4 and the one or more additional users 5, where the method 15 comprises evaluating one or more categories of information including: 1) past actions in the electronic sales and marketing system carried out by the user 4 and the one or more additional users 5, 2) past purchases by the user 4 and the one or more additional users 5, 3) past positive interactions 8 with posts 6 by the user 4 and the one or more additional users 5, 4) interests 10 expressed by the user 4 and the one or more additional users 5, and 5) past reviews written by the user 4 and the one or more additional users 5, where the method 15 additionally includes comparing the data from those categories and establishing if there are commonalities between the user 4 and the one or more additional users 5 in the data set 18 containing the categories that include one or more of: 1) past actions in the electronic sales and marketing system carried out by the user 4 and the one or more additional users 5, 2) past purchases by the user 4 and the one or more additional users 5, 3) past positive interactions 8 with posts 6 by the user 4 and the one or more additional users 5, 4) interests 10 expressed by the user 4 and the one or more additional users 5, and 5) past reviews written by the user 4 and the one or more additional users 5. The system preferably evaluates one or more of: if two or more users 4 have purchased the same or similar products, services or items for sale; if two or more users 4 have rated the same or similar posts 6 with similar ratings; if two or more users 4 have rated the same or similar posts 6 highly; if two or more users 4 have reviewed the same or similar posts 6, products, services, or items for sale highly, or have left reviews for the same or similar posts 6, products, services, or items for sale; if two or more users 4 have designated that they have the same or similar interests 10, which can include hobbies, sports, recreational activities, travel, lifestyles, leisure activities, professions, personal needs, family needs, health requirements or ailments, fashion preferences, entertainment preferences, and other interests 10; and the system then uses comparisons in at least one of these categories to determine a rating of commonality between two or more users 4. The ratings of commonality may take a form such as a number of similar data points out of the total number of data points compared, though ratings of commonality may take any suitable form. The ratings of commonality may be separated into different sectors or categories, such as sports, entertainment, hobbies, recreation, travel, health, lifestyles, family, fashion, and other suitable categories. Two or more users 4 might have rankings that suggest a similarity between them in one or more categories, but may also have rankings that do not suggest similarity in one or more other categories. Ratings of commonality may, however, be created or calculated by any suitable means. Ratings of commonality may also, however, be separated into any suitable categories or no categories at all. Preferably, if there are two or more commonalities among the data set 18 of 1) past actions in the electronic sales and marketing system by the user 4 and the one or more additional users 5, 2) past purchases by the user 4 and the one or more additional users 5, 3) past positive interactions 8 with posts 6 by the user 4 and the one or more additional users 5, 4) interests 10 expressed by the user 4 and the one or more additional users 5, and 5) past reviews by the user 4 and the one or more additional users 5, the method 15 assumes the one or more additional users 5 may also be interested in one or more of A) products for sale 7 that at least one of the users 4 has expressed interest in, B) at least one a service for sale that at least one of the users 4 has expressed interest in, and C) at least one item for sale to a user 4 that at least one of the users 4 has expressed interest in. In several variations, the system may infer common interests 11 between two or more users 4 if they have at least one, at least two, at least three, at least five, at least seven, at least ten, at least fifteen, at least twenty, at least thirty, or at least fifty similarities or commonalities in the stored data set 18 regarding one or more of 1) past actions in the electronic sales and marketing system by the user 4 and the one or more additional users 5, 2) past purchases by the user 4 and the one or more additional users 5, 3) past positive interactions 8 with posts 6 by the user 4 and the one or more additional users 5, 4) interests 10 expressed by the user 4 and the one or more additional users 5, and 5) past reviews by the user 4 and the one or more additional users 5. Common interests 11 may, however, be assumed by any appropriate means. Preferably, expressing interest in a product, service, or item for sale can include purchasing, rating positively, reviewing positively, or sharing with additional users 5, however expressing interest in a product, service, or item for sale may include any suitable interaction 8 between a user 4 and a post 6, product, service, or item for sale. Preferably, if a group of two or more users 4 have commonality ratings suggesting they may be interested in the same products, services or items for sale, and one or more of the two or more users 4 has expressed interest in the product, service or item for sale, the system infers that the additional users 5 in the group of two or more users 4 may also be interested in the product, service or item for sale. Preferably, if two or more of the users 4 in the group of two or more users 4 have indicated that they have a social connection 9, or have elected to be in the same common user group 14 within the system of the preferred embodiments, the system of the preferred embodiments shows some or all of the posts 6 that the two or more users 4 express interest in to the other of the two or more users 4. If there is a group of five users 4 that have a commonality rating suggesting they will be interested in the same products, services, or items for sale, and three of the users 4 have either indicated that they have a social connection 9 or have elected to be in the same common user group 14 in the system, then those three users 4 will be shown some or all of the posts 6 that the additional users 5 in the group of three express interest in. The system may, however, use commonality ratings to show posts 6 to additional users 5 in any suitable way. Preferably, the system uses commonality ratings in the same category as the product, service, or item for sale shown in a given post 6 in order to determine what users 4 the post 6 might be shown to; as one example, a post 6 relating to sports equipment would be eligible for display between users 4 that have a commonality rating suggesting they have common interests 11 in sports. Any suitable interrelation between categories of commonality ratings and posts 6 may, however, be used by the system, and the system may not use any interrelations between categories of commonality ratings.

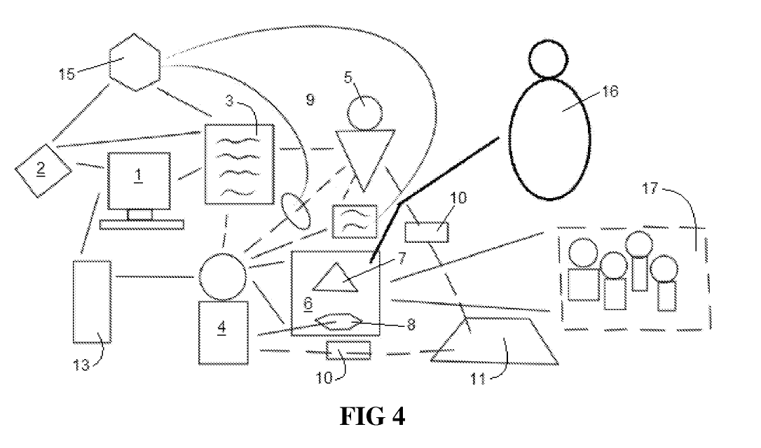

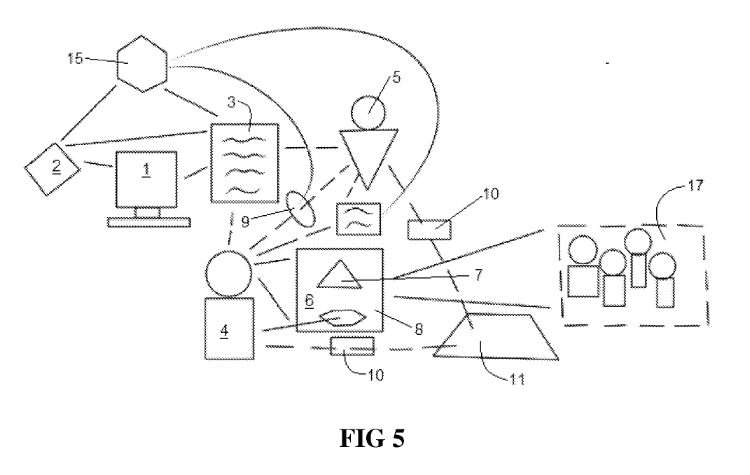

As shown in FIG. 4 and FIG. 5 a sellers 16 or company 16 can create a post 6 related to one or more of A) one or more product for sale, B) one or more services for sale 7, or C) one or more items for sale 7 to a user 4, and the system preferably shows the new post 6 to a group of users 17 automatically after the creation of the post 6. The group of users 17 preferably includes at least ten users. In another variation the group of users 17 includes at least fifty users. In another variation the group of users 17 preferably includes at least one hundred users. In another variation the group of users 17 preferably includes at least five hundred users. In another variation the group of users 17 preferably includes at least one thousand users. In another variation the group of users 17 includes at least five thousand users. In another variation the group of users 17 includes at least ten thousand users. In another variation the group of users 17 includes at least fifty thousand users 4. In another variation the group of users 17 includes at least one hundred thousand users. In another variation the group of users 17 includes at least two hundred and fifty thousand users. The system may, however, show the new post 6 to any suitable size of group of users 17 or may not automatically show the new post 6 to any users 4 at all. In a variation of the system of the first preferred embodiments, the system randomly chooses the group of users 17 that a new post 6 will be automatically shown to from a group of users 17 that the system has reason to believe may be interested in the new post 6. The system preferably chooses the group of users 17 that a new post 6 is shown to by taking into account if the users in the group of users 17 have one or more of 1) expressed interests 10 that suggest they may be interested in the post 6, and 2) one or more of 11) carried out past actions in the electronic sales and marketing system that suggest they may be interested in the post 6, 22) carried out past purchases that suggest they may be interested in the post 6, 33) carried out past positive interactions 8 with posts 6 that suggest they may be interested in the post 6, and 44) reviewed posts 6 in the past that suggest they may be interested in the post 6. The data set 18 of expressed interests and past actions of the user 4 with the system can be used to determine if the user 4 may be interested in a post 6 by drawing statistical correlations between the interactions 8 the user 4 has had with posts having certain characteristics, and the characteristics of the post 6. This filtering of the group of users that the system automatically shows a new post 6 is intended to select only users 4 that the system has information 3 indicating that the users 4 may be interested in the new post 6. It is preferred to not automatically show new posts 6 to users 4 that the system does not have information 3 to suggest they may be interested in the new post 6. The system may, however, use any suitable process to select the users 4 to automatically show a new post 6 to. In one variation of the system, the system shows the new post 6 automatically to a group of users 17 and tracks the number and types of positive interactions 8 those users 4 have with the new post 6, and the system then shows the post 6 to additional users 5 if the new post 6 has a higher than average number and quality of positive interactions 8 with the initial group of users 17. Preferably the number of additional users 5 the system shows the post 6 to is relative to the number and quality of positive interactions 8 users 4 have with the post 6, and preferably the number of additional users 5 the system shows the post 6 to changes in relation to the changing number and quality of interactions 8 users 4 have with the post 6. The system may, however, show the post 6 to additional users 5 with any suitable strategy and taking into account any suitable information, or may not show the post 6 to any additional users 5 at all. In one variation of the system, the system shows new posts 6 from sellers 16 to users 4 that have historically shown activity including one or more of I) positive interactions 8 with posts 6 recently created by sellers 16, II) positive interactions 8 with new posts 6, III) positive interactions 8 with posts 6 that the user's 4 social connections 9 in the system have not yet interacted with, IV) interacting with that user's 4 social connections 9 in the system more frequently than the average user 4, or V) sharing posts 6 more frequently with additional users 5 than the average user 4 of the system. This preferably allows the system to determine and show new or recent posts 6 to users 4 that would be considered in sociology terms social connectors or mavens.

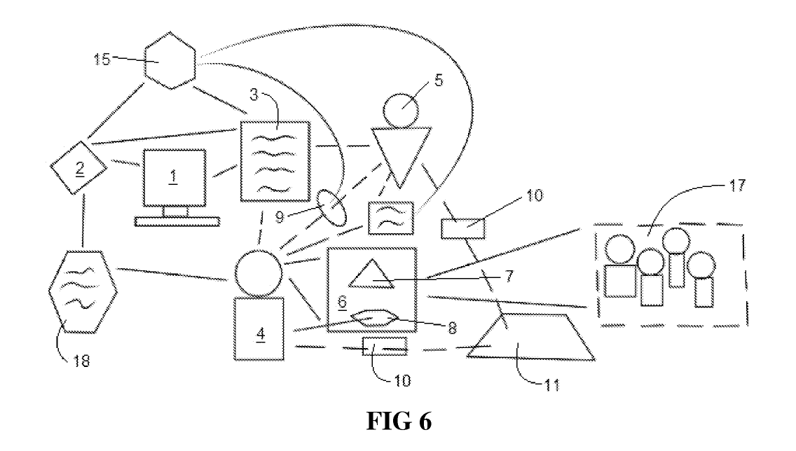

As shown in FIG. 6, in a preferred variation of the system of the preferred embodiments, a post 6 is not shown to the user 4 if the system does not have information 3 suggesting that the user 4 may be interested in the post 6. This is done to preferably avoid bothering or unnecessarily bombarding users 4 with posts 6 that they are unlikely to be interested in. Preferably, the information 3 stored on the computer-readable medium that suggests the user 4 may be interested in the post 6 includes one or more of 1) past actions in the electronic sales and marketing system by the one or more user 4, 2) past purchases by the one or more user 4, 3) past positive interactions 8 with posts 6 by the one or more user 4, 4) interests 10 expressed by the one or more user 4, 5) past reviews by the one or more user 4, 6) interests 10 expressed by the one or more user 4, and 7) one or more commonality in the previously listed data categories 1-6 between the one or more user 4 and at least one additional user 4, where the at least one additional user 4 has one or more of A) expressed a social connection 9 with the one or more user 4, or B) elected to be in one or more common user groups 14 with the one or more user 4. The system may, however, show or not show posts 6 to users 4 based on the presence or absence of any information 3.

As shown in FIG. 6 if a user 4 purchases one or more of A) one or more products for sale 7, B) one or more services for sale 7, or C) one or more items for sale 7 to a user 4, then one or both of 1) a portion of the proceeds 21 from the sale 19 or 2) a standardized commission 21, is retained or separated from the total proceeds 19 by the electronic sales and marketing system and is transferred to the company 22 that runs the electronic sales and marketing system. Preferably the system takes a commission 21 or cut 21 of all proceeds 19 from all sales transacted through the system. However, the system may take any suitable compensation 21, or none at all. In another variation of the system of the preferred embodiments, the system may also allow pre-sell options for products that either do not exist or where the seller needs to raise money to complete orders. The pre-sell option may include a goal in terms of total number of units sold, or total dollars of pre-sales, where the orders for the pre-sold items, products, or services do not have to be fulfilled or completed unless the goal level is reached for either total units sold, total dollars of pre-sales achieved, or both. The system may, however, sell any of items, products, or services in any suitable manner.

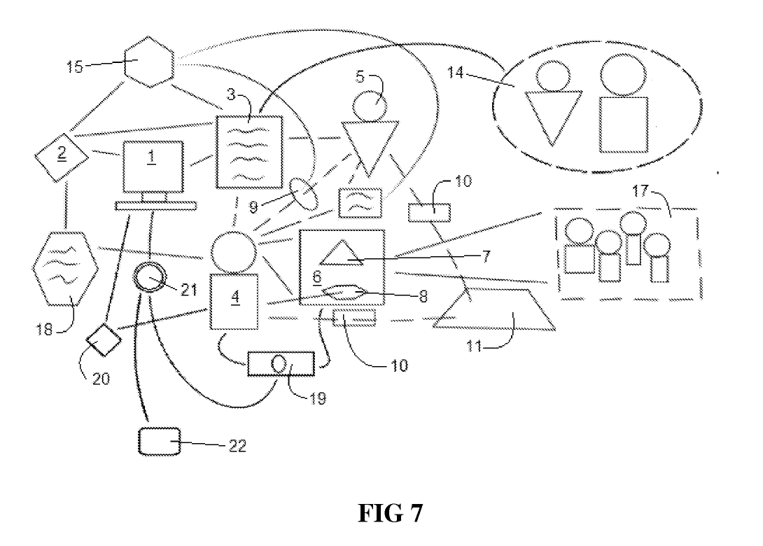

As shown in FIG. 7, in a preferred variation of the system of the preferred embodiments rewards 20 are provided to users 4 who carry out one or more of A) a certain number of actions and B) a certain rate of actions from the group of 1) purchases by the at least one user 4, 2) past positive interactions 8 with posts 6 by the at least one user 4, 3) reviews by the at least one user 4. Preferably users 4 that purchase a large number of items or services 7, or help spread and review information related to items and services for sale 7 in the system, or both receive rewards 20 to encourage continued usage of the system. These rewards 20 can include one or more of 1) additional discounts 12 on purchases, 2) points towards free purchases, 3) credit towards future purchases, and 4) gifts. Gifts can include coupons, travel vouchers, products the user 4 might be interested in, free services, other products, or any suitable gifts. The system may also provide rewards 20 to users 4 for signing up other people as additional users 5 of the system, and may additionally provide rewards 20 for the actions of people the user 4 has signed up as additional users 5 of the system. The system may, however, provide any suitable rewards 20 to users 4 for any suitable reasons, or may not provide rewards 20 at all.

Preferably the system compares new posts 6 to old posts 6 to ensure that sellers 16 do not make new posts 6 that are similar to, or nearly identical to, old posts 6 in order to prevent manipulation of the system by repeated post 6 of the same products, items, or services for sale 7. The system of the preferred embodiments may, however, compare posts 6 to old posts 6 in any suitable manner, or may compare posts 6 to any suitable set of criteria, or may not compare posts 6 to any overview procedure.

As a person skilled in the prior art will recognize after examination of the previous detailed description and the figures and claims, modifications and changes may be made to the preferred embodiments of the invention without departing from the scope of the invention as defined in the following claims.

I claim:

1. An electronic sales and marketing system comprising an algorithm stored on computer-readable medium and executed by at least one networked computer device, wherein the algorithm comprises: showing a post containing at least one of A) at least one product for sale, B) at least one a service for sale, and C) at least one item for sale to a user; accessing information stored in computer-readable medium related to at least one other user if the user at least one of: 1) designates that they feel positively about the post, 2) makes a purchase related to the contents of the post, and 3) at least one of rates and reviews the contents of the post; showing at least a portion of the contents of the post to at least one additional user wherein the information related to the at least one other user at least one of I) suggests a social connection exists between the at least one user and the at least one additional user, and II) shows that the at least one user and the at least one additional user have elected to be in at least one common group within the system, wherein additionally the information at least one of i) suggests there may be at least one common interest between the at least one user and the at least one additional user, and ii) shows that the at least one user and the at least one additional user have stated that they have interests in at least one common area, wherein the system further comprises the ability to purchase through the electronic sales and marketing system at least one of A) at least one product for sale, B) at least one a service for sale, and C) at least one item for sale to a user, wherein at least one of the: 11) required bandwidth, 22) processing resources required, and 33) memory access requirements of the at least one networked computing device are reduced compared to the requirements of related systems that do not utilize information comprising information that at least one of i) suggests there may be at least one common interest between the at least one user and the at least one additional user, and ii) shows that the at least one user and the at least one additional user have stated that they have interests in at least one common area.

2. The electronic sales and marketing system of claim 1 wherein the algorithm comprises at least one of A) at least one message displayed to the at least one user discouraging posts related to content not related to at least one of 1) at least one product for sale, 2) at least one a service for sale, and 3) at least one item for sale to a user, and B) rules of conduct governing the activity of the users discouraging posts related to content not related to at least one of 1) at least one product for sale, 2) at least one a service for sale, and 3) at least one item for sale to a user.

3. The electronic sales and marketing system of claim 2 wherein the rules of conduct for sellers using the electronic sales and marketing system require that the sellers provide discounts compared to at least one of A) market value, B) the standard sales price, and C) the minimum sales price in the market for at least one of 1) at least one product for sale, 2) at least one a service for sale, and 3) at least one item for sale to a user.

4. The electronic sales and marketing system of claim 1 wherein the algorithm further comprises a method to determine if information stored in computer-readable medium related to at least one user and at least one additional user suggest there may be at least one common interest between the at least one user and the at least one additional user, wherein the method comprises evaluating at least one of 1) past actions in the electronic sales and marketing system by the at least one user and the at least one additional user, 2) past purchases by the at least one user and the at least one additional user, 3) past positive interactions with posts by the at least one user and the at least one additional user, 4) interests expressed by the at least one user and the at least one additional user, and 5) past reviews by the at least one user and the at least one additional user, wherein the method further comprises establishing if there are commonalities between the at least one user and the at least one additional user in the at least one of 1) past actions in the electronic sales and marketing system by the at least one user and the at least one additional user, 2) past purchases by the at least one user and the at least one additional user, 3) past positive interactions with posts by the at least one user and the at least one additional user, 4) interests expressed by the at least one user and the at least one additional user, and 5) past reviews by the at least one user and the at least one additional user.

5. The electronic sales and marketing system of claim 4 wherein if there are at least two commonalities among the set of 1) past actions in the electronic sales and marketing system by the at least one user and the at least one additional user, 2) past purchases by the at least one user and the at least one additional user, 3) past positive interactions with posts by the at least one user and the at least one additional user, 4) interests expressed by the at least one user and the at least one additional user, and 5) past reviews by the at least one user and the at least one additional user, the method infers that at least one of the additional users may also be interested in at least one of A) at least one product for sale that at least one of the users has expressed interest in, B) at least one a service for sale that at least one of the users has expressed interest in, and C) at least one item for sale to a user that at least one of the users has expressed interest in.

6. The electronic sales and marketing system of claim 4 wherein if there are at least five commonalities among the set of 1) past actions in the electronic sales and marketing system by the at least one user and the at least one additional user, 2) past purchases by the at least one user and the at least one additional user, 3) past positive interactions with posts by the at least one user and the at least one additional user, 4) interests expressed by the at least one user and the at least one additional user, and 5) past reviews by the at least one user and the at least one additional user, the method infers that the at least one user and the at least one additional user may have shared interests in at least one of A) at least one product for sale that at least one of the users has expressed interest in, B) at least one a service for sale that at least one of the users has expressed interest in, and C) at least one item for sale to a user that at least one of the users has expressed interest in.

7. The electronic sales and marketing system of claim 1 wherein sellers can post for sale at least one of A) at least one product for sale, B) at least one a service for sale, and C) at least one item for sale to a user, wherein the posting will be automatically shown to at least ten users, wherein the at least ten users have at least one of 1) expressed interests that suggest they may be interested in the posting, and 2) at least one of I) carried out past actions in the electronic sales and marketing system that suggest they may be interested in the posting, II) carried out past purchases that suggest they may be interested in the posting, III) carried out past positive interactions with posts that suggest they may be interested in the posting, and IV) reviewed posts in the past that suggest they may be interested in the posting.

8. The electronic sales and marketing system of claim 1 wherein sellers can post for sale at least one of A) at least one product for sale, B) at least one a service for sale, and C) at least one item for sale to a user, wherein the posting will be automatically shown to at least one thousand users, wherein the at least one thousand users have at least one of 1) expressed interests that suggest they may be interested in the posting, and 2) at least one of I) carried out past actions in the electronic sales and marketing system that suggest they may be interested in the posting, II) carried out past purchases that suggest they may be interested in the posting, III) carried out past positive interactions with posts that suggest they may be interested in the posting, and IV) reviewed posts in the past that suggest they may be interested in the posting.

9. The electronic sales and marketing system of claim 1 wherein sellers can post for sale at least one of A) at least one product for sale, B) at least one a service for sale, and C) at least one item for sale to a user, wherein the posting will be automatically shown to at least ten thousand users, wherein the at least ten thousand users have at least one of 1) expressed interests that suggest they may be interested in the posting, and 2) at least one of I) carried out past actions in the electronic sales and marketing system that suggest they may be interested in the posting, II) carried out past purchases that suggest they may be interested in the posting, III) carried out past positive interactions with posts that suggest they may be interested in the posting, and IV) reviewed posts in the past that suggest they may be interested in the posting.

10. The electronic sales and marketing system of claim 8 wherein if a user purchases at least one of A) at least one product for sale, B) at least one a service for sale, and C) at least one item for sale to a user, at least one of 1) a portion of the proceeds from the sale and 2) a standardized commission is retained by the electronic sales and marketing system and is transferred to the company that runs the electronic sales and marketing system.

11. The electronic sales and marketing system of claim 1 wherein a post is not shown to the at least one user if there is not information stored on the computer-readable medium that suggests the user may be interested in the post.

12. The electronic sales and marketing system of claim 11, wherein the information stored on the computer-readable medium that suggests the user may be interested in the post comprises at least one of 1) past actions in the electronic sales and marketing system by the at least one user, 2) past purchases by the at least one user, 3) past positive interactions with posts by the at least one user, 4) interests expressed by the at least one user, 5) past reviews by the at least one user, 6) interests expressed by the at least one user, and 7) at least one commonality in at least one of 1-6 between the at least one user and at least one additional user that at least one of A) has an expressed social connection with the at least one user, and B) has elected to be in at least one common group with the at least one user.

13. The electronic sales and marketing system of claim 4 wherein a post is not shown to the at least one user if there is not information stored on the computer-readable medium that suggests the user may be interested in the post.

14. The electronic sales and marketing system of claim 13, wherein the information stored on the computer-readable medium that suggests the user may be interested in the post comprises at least one of 1) past actions in the electronic sales and marketing system by the at least one user, 2) past purchases by the at least one user, 3) past positive interactions with posts by the at least one user, 4) interests expressed by the at least one user, 5) past reviews by the at least one user, 6) interests expressed by the at least one user, and 7) at least one commonality in at least one of 1-6 between the at least one user and at least one additional user that at least one of A) has an expressed social connection with the at least one user, and B) has elected to be in at least one common group with the at least one user.

15. The electronic sales and marketing system of claim 3 wherein a post is not shown to the at least one user if there is not information stored on the computer-readable medium that suggests the user may be interested in the post.

16. The electronic sales and marketing system of claim 15, wherein the information stored on the computer-readable medium that suggests the user may be interested in the post comprises at least one of 1) past actions in the electronic sales and marketing system by the at least one user, 2) past purchases by the at least one user, 3) past positive interactions with posts by the at least one user, 4) interests expressed by the at least one user, 5) past reviews by the at least one user, 6) interests expressed by the at least one user, and 7) at least one commonality in at least one of 1-6 between the at least one user and at least one additional user that at least one of A) has an expressed social connection with the at least one user, and B) has elected to be in at least one common group with the at least one user.

17. The electronic sales and marketing system of claim 8 wherein a post is not shown to the at least one user if there is not information stored on the computer-readable medium that suggests the user may be interested in the post.

18. The electronic sales and marketing system of claim 15, wherein the information stored on the computer-readable medium that suggests the user may be interested in the post comprises at least one of 1) past actions in the electronic sales and marketing system by the at least one user, 2) past purchases by the at least one user, 3) past positive interactions with posts by the at least one user, 4) interests expressed by the at least one user, 5) past reviews by the at least one user, 6) interests expressed by the at least one user, and 7) at least one commonality in at least one of 1-6 between the at least one user and at least one additional user that at least one of A) has an expressed social connection with the at least one user, and B) has elected to be in at least one common group with the at least one user.

19. The electronic sales and marketing system of claim 5 wherein rewards are provided to users who carry out at least one of A) a certain number of actions and B) a certain rate of actions from the group of 1) purchases by the at least one user, 2) past positive interactions with posts by the at least one user, 3) reviews by the at least one user.

20. The electronic sales and marketing system of claim 19 wherein rewards comprise at least one of 1) additional discounts on purchases, 2) points towards free purchases, 3) credit towards future purchases, and 4) gifts.
